(19) United States
(12) Patent Application Publication
(10) Pub. No.: US 2025/0327490 A1
(43) Pub. Date: Oct. 23, 2025

(54) HEAT TRANSFER AIDE FOR TUBE MOUNT MONO-BLOCK CONSTANT JOINT ASSEMBLY

(71) Applicant: Dana Automotive Systems Group, LLC, Maumee, OH (US)

(72) Inventor: Donald W. DINE, Whitehouse, OH (US)

(21) Appl. No.: 19/182,395

(22) Filed: Apr. 17, 2025

Related U.S. Application Data
(60) Provisional application No. 63/635,793, filed on Apr. 18, 2024.

(51) Int. Cl. F16D 3/84; F16D 3/02; F16D 3/22

(52) U.S. Cl. CPC F16D 3/84; F16D 3/02; F16D 3/22; F16D 2200/0034; F16D 2250/0076

(57) ABSTRACT

The following description relates to a constant velocity joint (CVJ) included in a greater joint assembly. The joint assembly comprises: a CVJ having an outer race with a weld seat; a flange component with a weld seat projection on a first side, where the weld seat projection is configured to mate with the weld seat of the outer race; a conductive component that joins the outer race and the flange component at an interface between the outer race and a second side of the flange component, opposite the first side; and a shaft component drivingly coupled to the constant velocity joint, where the constant velocity joint is received by and drivingly coupled to the shaft component at the weld seat of the outer race.

### CROSS REFERENCE TO RELATED APPLICATIONS

The present application claims priority to U.S. Provisional Application No. 63/635,793, entitled “HEAT TRANSFER AIDE FOR TUBE MOUNT MONO-BLOCK CONSTANT JOINT ASSEMBLY”, and filed on Apr. 18, 2024. The entire contents of the above-listed application are hereby incorporated by reference for all purposes.

### TECHNICAL FIELD

The present description relates to a constant velocity joint assembly with a thermal conductive resin and/or a thermal conductive insert material that conducts from an interface between an outer race and a flange component coupled to the outer race.

### BACKGROUND AND SUMMARY

Vehicles may have a transmission to switch gears of a plurality of different ratios, where each of the different ratios may output different torques and rotational speeds with the same input torque. Likewise, vehicles may have a plurality of axle assemblies including axles. Rotational elements, such as driveshafts, may drivingly couple a transmission, and/or another component that includes and/or drivingly couples to a transfer case, to an axle such that torque from the transmission and/or another component may drive the axle. Rotational elements of the vehicle, including driveshafts, may be rotationally coupled via joints, such as via one or more constant velocity joints (CVJs). CVJs may drivingly couple driveshafts to outputs from the transmission and/or other transfer cases, and CVJs may drivingly couple driveshafts to inputs to axle assemblies.

An interface between a CVJ assembly and the axle and/or transfer case may include a cup shaped flange (e.g., a cup shaped companion flange). The cup shaped flange may be rotationally coupled to the CVJ using fasteners, such as bolts. The interface and fasteners may have a desired area of contact. The desired area of contact may also be key to facilitating heat transfer during normal running conditions at a rate to reduce degradation to the CVJ and the CVJ assembly such that heat accumulated in the CVJ or the flange is maintained below a temperature threshold. However, a CVJ assembly may include non-optimal interfaces, where the areas of contact between the CVJ, the flange, and/or the fasteners, are below the desired area of contact, due to factors such as low production volumes, packaging constraints, or customer constraints. Additionally, a CVJ and flange may be drivingly coupled at the interface without fasteners and via welding for the reasons listed above, but with reduced heat transfer.

The inventors herein have recognized these and other issues with such systems and have come up with a way to at least partially solve them. As developed in one example, is a joint assembly, comprising a constant velocity joint having an outer race with a weld seat; a flange component with a weld seat projection on a first side, where the weld seat projection is configured to mate with the weld seat of the outer race; a conductive component that joins the outer race and the flange component at an interface between the outer race and a second side of the flange component, opposite the first side; and a shaft component drivingly coupled to the constant velocity joint, where the constant velocity joint is received by and drivingly coupled to the shaft component at the weld seat of the outer race.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic of a vehicle which may include one or more of the constant velocity joints (CVJs) of the present disclosure.

FIG. 2 shows a sectional view of a joint assembly including a constant velocity joint (CVJ) of the present disclosure.

FIG. 3 shows a sectional view of the joint assembly including the CVJ of the present disclosure with a thermally conductive feature of the present disclosure applied.

FIG. 4 shows a first method of assembling a joint assembly including the CVJ of the present disclosure.

FIG. 5 shows a second method of assembling a joint assembly including the CVJ of the present disclosure.

### DETAILED DESCRIPTION

The following description relates to a constant velocity joint (CVJ) included in a greater joint assembly. The joint assembly comprises: the CVJ, which has an outer race with a weld seat; and a flange component with a weld seat projection on a first side, where the weld seat projection is configured to mate with the weld seat of the outer race. A conductive component is positioned between and joins the outer race and the flange component at an interface between the outer race and a second side of the flange component. The joint assembly further includes a shaft component that is drivingly coupled to the CVJ, where the CVJ is received by and drivingly coupled to the shaft component at the weld seat of the outer race. The weld seat of the outer race includes a grease cover to retain liquid (e.g., lubricant) in the outer race and prevent dust and other debris from entering the outer race. The CVJ may be configured as a tube mount mono-block (TMMB). The flange component may include one or more additional projections configured to physically coupled the flange component to another flange, such as a flange of an axle, transfer case, high speed propeller shaft, and/or transmission. The conductive component may be formed of a resin of a thermo-conductive material, may be a low melting point metal, and/or may be a thermally conductive inert material such as graphite. The conductive component may be in face-sharing contact with the flange component (e.g., with the weld seat projection) and with the outer race of the CVJ. The CVJ may further be coupled to the flange component via a plurality of means, such as fasteners, magnetic arc welding, and/or friction welding.

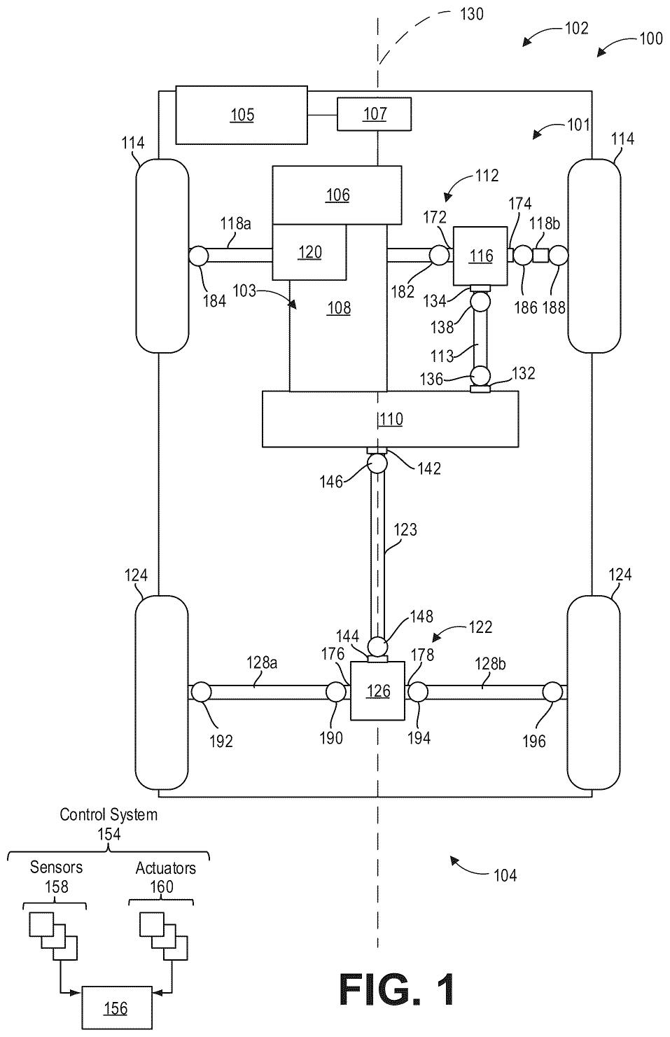

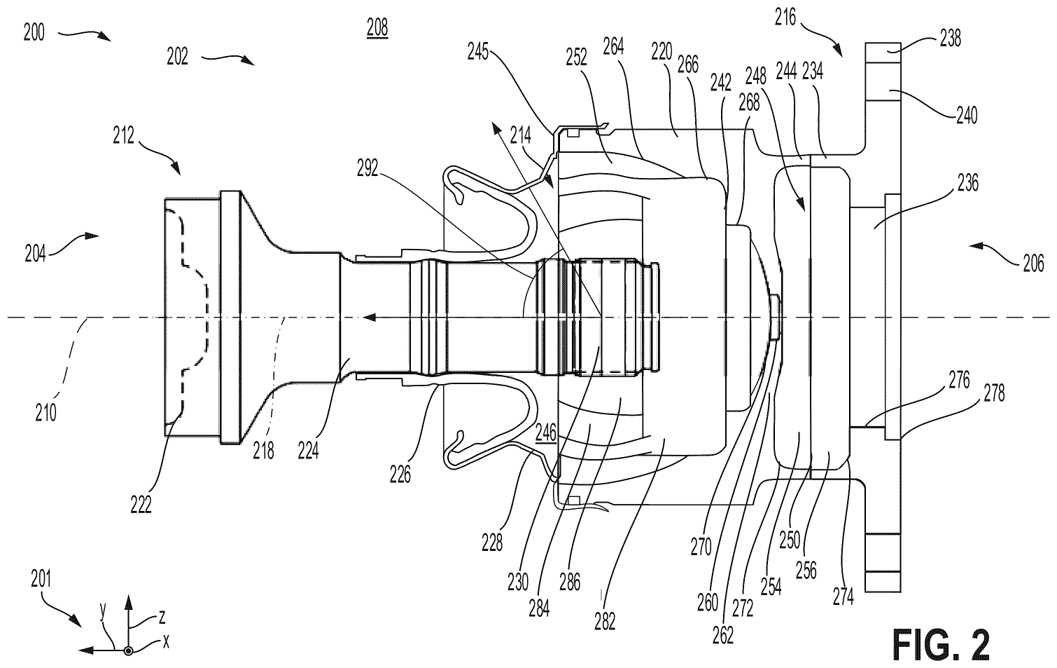

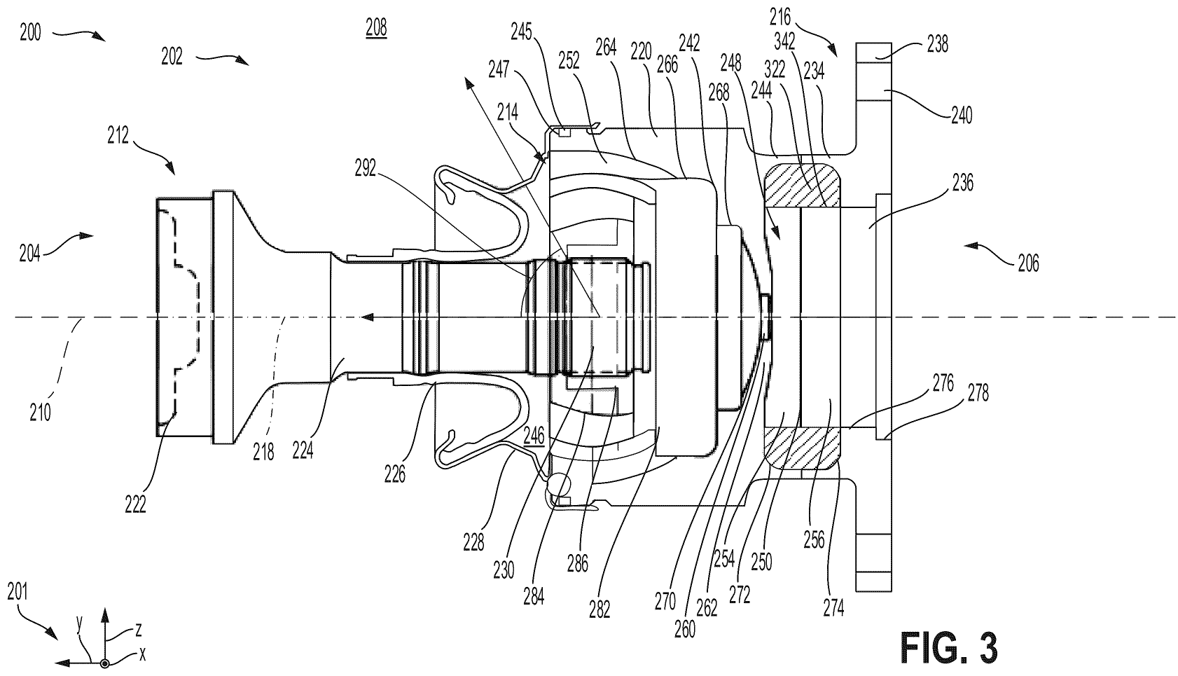

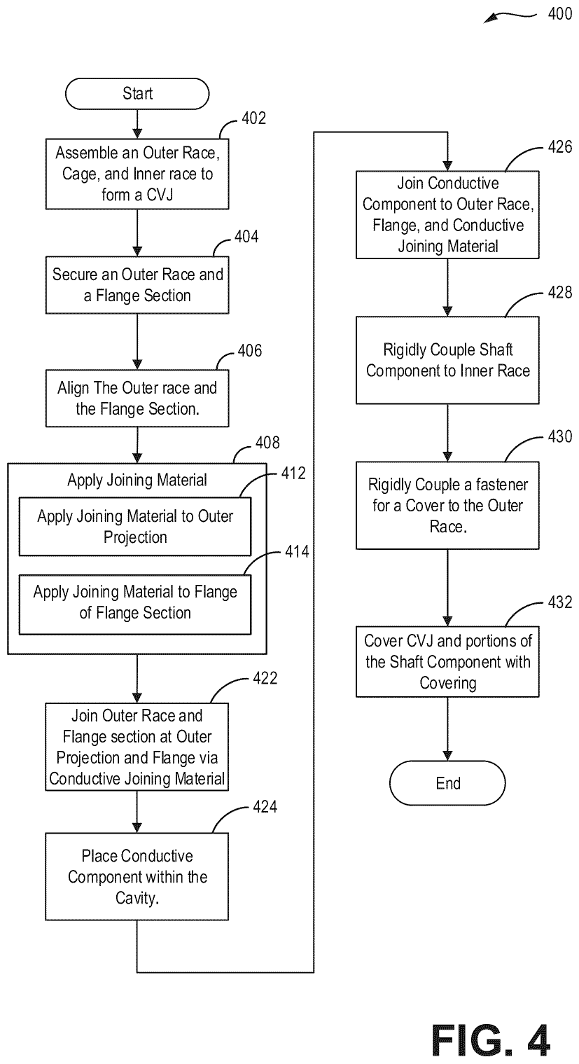

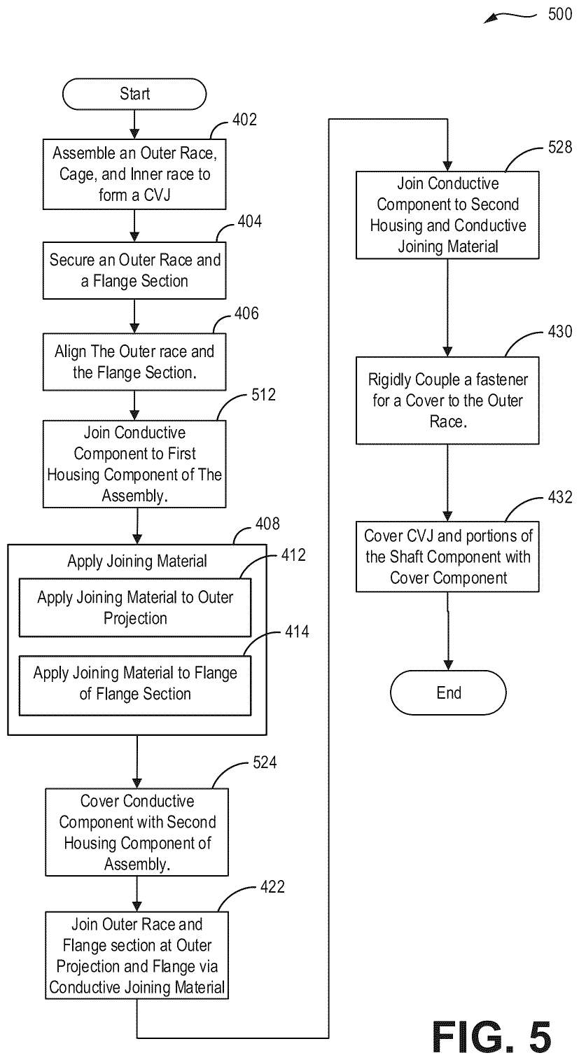

FIG. 1 shows an example schematic of a vehicle which may include one or more of the CVJs of the present disclosure. FIG. 2 shows sectional view of a CVJ and joint assembly of the present disclosure. FIG. 3 shows a sectional view of the CVJ and joint assembly of the present disclosure with a thermally conductive feature the present disclosure applied. FIG. 4 shows a method of assembling a joint assembly including the CVJ of the present disclosure. FIG. 5 shows a second method of assembling a joint assembly include the CVJ of the present disclosure. The method of FIG. 4 includes forming and joining a conductive component, such as a component comprising a thermally conductive resin, to surfaces of both an outer race and a flange component and to a joining material therebetween via an additive manufacturing method. The method of FIG. 5 includes inserting the conductive component as a premade component and joining the premade component to surfaces of the outer race and the flange component and a joining material therebetween. The additive manufacturing method and joining of the first method and the second method of FIGS. 4-5 may be accomplished via welding and/or soldering of thermally conductive material.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIG. 1 shows a schematic of an example configuration with relative positioning of the various components. FIGS. 2-3 show example configurations with approximate position. FIGS. 2-3 are shown approximately to scale; though other relative dimensions may be used. As used herein, the terms “approximately” is construed to mean plus or minus five percent of the range unless otherwise specified.

Further, FIGS. 1-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

Turning now to FIG. 1, a vehicle 100 is shown comprising a powertrain 101 and a drivetrain 103. The vehicle 100 may have a front end 102 and a rear end 104, located on opposite sides of vehicle 100. Objects, components, and features of the vehicle 100 referred to as being located near the front may be closest to the front end 102 compared to the rear end 104. Objects, components, and features of the vehicle 100 referred to as being located near the rear may be closest to the rear end 104 compared to the front end 102. The powertrain 101 comprises a prime mover 106 and a transmission 108. The prime mover 106 may be an internal combustion engine (ICE) or an electric motor, for example, and is operated to provide rotary power to the transmission 108. The transmission 108 may be any type of transmission, such as a manual transmission, an automatic transmission, or a continuously variable transmission. Additionally, the transmission 108 may be or include a gearbox. The transmission 108 receives the rotary power produced by the prime mover 106 as an input and outputs rotary power to the drivetrain 103 in accordance with a selected gear or setting. Additionally, there may be other movers in the vehicle besides prime mover 106 such as a second mover 120.

In some examples, additionally or alternatively, the vehicle 100 may be a hybrid vehicle including both an engine and an electric machine each configured to supply power to one or more of the first axle assembly 112 and the second axle assembly 122. For example, one or both of the first axle assembly 112 and the second axle assembly 122 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 112 and the second axle assembly 122 may be an electric axle assembly configured to be driven by an integrated electric machine.

For example, if the prime mover 106 is an ICE and the vehicle 100 is a hybrid vehicle, there may be at least another mover with an input to the transmission 108 besides prime mover 106. The other mover may be an electric machine, such as an electric motor. For this example, the second mover 120 may be the other mover and an electric machine. In one example, if there are a single or plurality of second movers in addition to the prime mover 106, the vehicle 100 may be a hybrid vehicle, wherein there are multiple torque inputs to the transmission 108. The vehicle 100 may have a longitudinal axis 130. The powertrain 101 and drivetrain 103 may have a length parallel with the longitudinal axis 130.

The prime mover 106 may be powered via energy from an energy storage device 105. In one example, the energy storage device 105 is a battery, such as a traction battery, configured to store electrical energy. An inverter 107 may be arranged between the energy storage device 105 and the prime mover 106 and configured to adjust direct current (DC) to alternating current (AC). The inverter 107 may include a variety of components and circuitry with thermal demands that effect an efficiency of the inverter.

The vehicle 100 may be a commercial vehicle, light, medium, or heavy duty vehicle, a passenger vehicle, an off-highway vehicle, a commercial vehicle, agricultural vehicle, and/or sport utility vehicle. For an example embodiment, the vehicle 100 may be a wheeled vehicle, such as an automobile. However, additionally or alternatively, the vehicle 100 may be plane, a boat, or other vehicle system. Additionally or alternatively, the vehicle 100 and/or one or more of its components, such as components of the powertrain 101 and/or drivetrain 103, may be used in industrial, locomotive, military, agricultural, and/or aerospace applications. In one example, the vehicle 100 is an all-electric vehicle or a vehicle with all-electric modes of operation, such as a plug-in hybrid vehicle. As such, the prime mover 106 may be an electric machine. In one example, the prime mover 106 may be an electric motor/generator.

In some examples, such as shown in FIG. 1, the drivetrain 103 includes a first axle assembly 112 and a second axle assembly 122. The first axle assembly 112 may be configured to drive a first set of wheels 114, and the second axle assembly 122 may be configured to drive a second set of wheels 124. In one example, the first axle assembly 112 is arranged near a front of the vehicle 100 and thereby comprises a front axle, and the second axle assembly 122 is arranged near a rear of the vehicle 100 and thereby comprises a rear axle. The drivetrain 103 is shown in a four-wheel drive configuration, although other configurations are possible. For example, the drivetrain 103 may include a rear-wheel drive, a front-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103. The vehicle 100 may have a first driveshaft 113 and/or a second driveshaft 123. The transmission 108 may drivingly couple the first driveshaft 113 and/or the second driveshaft 123. The transmission 108 may drivingly couple the first driveshaft 113 and/or the second driveshaft 123 via the transfer case 110. The first driveshaft 113 may drivingly couple the first axle assembly 112. The second driveshaft 123 may drivingly couple the second axle assembly 122. The transmission 108 may drivingly couple the first axle assembly 112 via the first driveshaft 113, such that torque may be transferred from the transmission 108 to the first axle assembly 112 via the first driveshaft 113. The transmission 108 may drivingly couple the second axle assembly 122 via the second driveshaft 123, such that torque may be transferred from the transmission 108 to the second axle assembly 122 via the second driveshaft 123.

The first axle assembly 112 may include a first differential 116 and a first set of axle shafts. The first differential 116 may drivingly couple the first set of axle shafts such as to transfer torque to and drive the first set of axle shafts. The first set of axle shafts may include a first shaft 118a and a second shaft 118b. The second axle assembly 122 may include a second differential 126 and a second set of axle shafts. The second differential 126 may drivingly couple the second set of axle shafts such as to transfer torque to and drive the second set of axle shafts. The second set of axle shafts may include a third shaft 128a and a fourth shaft 128b. The first set of axle shafts and the second set of axle shafts may be axle half shafts for the first axle assembly 112 and the second axle assembly 122, respectively. The first shaft 118a and the second shaft 118b may be axle half shafts for the first axle assembly 112. The third shaft 128a and the fourth shaft 128b may be axle half shafts for the second axle assembly 122. The first and second differentials 116, 126 may distribute unequal torque to each of the first set of axle shafts and each of the second set of axle shafts, respectively. For example, the first differential 116 may distribute unequal torque to the first shaft 118a and the second shaft 118b. Likewise, for this or another example, the second differential 126 may distribute unequal torque to the third shaft 128a and the fourth shaft 128b.

In some configurations, such as shown in FIG. 1, the drivetrain 103 includes a transfer case 110 configured to receive rotary power output by the transmission 108. The first driveshaft 113 is drivingly coupled to a first output 132 of the transfer case 110, while the second driveshaft 123 is drivingly coupled to a second output 142 of the transfer case 110. The first driveshaft 113 may drivingly couple the first differential 116 via a first input 134. The first driveshaft 113 (e.g., a front driveshaft) transmits rotary power from the transfer case 110 to a first differential 116 of the first axle assembly 112 to drive the first set of wheels 114, while the second driveshaft 123 (e.g., a rear driveshaft) transmits the rotary power from the transfer case 110 to a second differential 126 of the second axle assembly 122 to drive the second set of wheels 124. For example, the first differential 116 is drivingly coupled to a first set of axle shafts coupled to the first set of wheels 114, and the second differential 126 is drivingly coupled to a second set of axle shafts coupled to the second set of wheels 124. The first differential 116 may drivingly couple the first shaft 118a and the second shaft 118b. The second differential 126 may drivingly couple the third shaft 128a and the fourth shaft 128b. It may be appreciated that each of the first set of axle shafts and the second set of axle shafts may be positioned in a housing. The first driveshaft 113 and second driveshaft 123 may be positioned to extend in parallel with the longitudinal axis 130. For an example of a configuration of vehicle 100, the second driveshaft 123 may be centered about the longitudinal axis 130.

The first driveshaft 113 may drivingly couple the first differential 116 via a first input 134. Likewise, the second driveshaft 123 may drivingly couple the second differential 126 via a second input 144. The first driveshaft 113 and the second driveshaft 123 may drivingly couple to other rotational elements, such as their respective inputs and outputs, via a plurality of joints. For example, the first driveshaft 113 may drivingly couple to the first output 132 via a first joint 136. Additionally, the first driveshaft 113 may drivingly couple to the first input 134 via a second joint 138. Likewise, the second driveshaft 123 may drivingly couple to the second output 142 via a third joint 146. Additionally, the second driveshaft 123 may drivingly couple to the second input 144 via a fourth joint 148.

The first differential 116 may drivingly couple the first shaft 118a via a third output 172. The first differential 116 may drivingly couple the second shaft 118b via a fourth output 174. The second differential 126 may drivingly couple the third shaft 128a via a fifth output 176. The second differential 126 may drivingly couple the fourth shaft 128b via a sixth output 178. The first shaft 118a and the second shaft 118b may drivingly couple to other rotational elements, such as the third output 172 and the fourth output 174, respectively, and the first set of wheels 114, via a plurality of joints. For example, the first shaft 118a may drivingly couple to the third output 172 via a fifth joint 182. Additionally or alternatively, the first shaft 118a may drivingly couple a wheel of the first set of wheels 114 via a sixth joint 184. The second shaft 118b may drivingly couple to the fourth output 174 via a seventh joint 186. Additionally or alternatively, the second shaft 118b may drivingly couple a wheel of the first set of wheels 114 via an eighth joint 188. For this or another example, the third shaft 128a may drivingly couple to the fifth output 176 via a ninth joint 190. Additionally or alternatively, the third shaft 128a may drivingly couple a wheel of the second set of wheels 124 via a tenth joint 192. The fourth shaft 128b may drivingly couple to the sixth output 178 via an eleventh joint 194. Additionally or alternatively, the fourth shaft 128b may drivingly couple a wheel of the second set of wheels 124 via a twelfth joint 196.

The vehicle 100 and drivetrain 103 may include a plurality of CVJs. A CVJ may drivingly couple at least a first rotational element and a second rotational element, such as a first shaft and a second shaft, such that the first rotational element and the second rotational may rotate and/or pivot freely, and the first rotational element may drive the second rotational element, and vice versa, at an angle between the first rotational element and the second rotational element. The CVJ may compensate for the angle between the first rotational element and the second rotational element when the angle is between a range of threshold of angles. The angle between the first rotational element and the second rotational element may change during rotation, such as during operations of the suspension, where a position of the first axle or the second axle may change. The first joint 136, the second joint 138, the third joint 146, and/or the fourth joint 148 may be CVJs. Additionally or alternatively, the fifth joint 182, the sixth joint 184, the seventh joint 186, the eighth joint 188, the ninth joint 190, the tenth joint 192, the eleventh joint 194, and/or the twelfth joint 196 may be CVJs. Additionally, other CVJs may drivingly couple to other shafts and rotational elements of vehicle 100.

The first differential 116 may supply a FWD in some capacity to vehicle 100, as part of rotary power transferred via the first driveshaft 113. Likewise, the second differential 126 may supply a RWD to vehicle 100, as part of the rotary power transferred via the second driveshaft 123. The first differential 116 and the second differential 126 may supply a FWD and RWD, respectively, as part of an AWD mode for vehicle 100.

Adjustment of the drivetrain 103 between the various modes as well as control of operations within each mode may be executed based on a vehicle control system 154, including a controller 156. Controller 156 may be a microcomputer, including elements such as a microprocessor unit, input/output ports, an electronic storage medium for executable programs and calibration values, e.g., a read-only memory chip, random access memory, keep alive memory, and a data bus. The storage medium can be programmed with computer readable data representing instructions executable by a processor for performing the methods described below as well as other variants that are anticipated but not specifically listed. In one example, controller 156 may be a powertrain control module (PCM).

Controller 156 may receive various signals from sensors 158 coupled to various regions of vehicle 100. For example, the sensors 158 may include sensors at the prime mover 106 or another mover to measure mover speed and mover temperature, a pedal position sensor to detect a depression of an operator-actuated pedal, such as an accelerator pedal or a brake pedal, a lever position sensor to detect a shifting of a lever, such as a brake lever, speed sensors at the first and second set of wheels 114, 124, etc. Upon receiving the signals from the various sensors 158 of FIG. 1, controller 156 processes the received signals, and employs various actuators 160 of vehicle 100 to adjust drivetrain operations based on the received signals and instructions stored on the memory of controller 156. For example, controller 156 may receive an indication of depression of the brake pedal, signaling a desire for decreased vehicle speed. Vehicle braking may be directly proportional to accelerator pedal position, for example, degree of depression. For another example, controller 156 may receive an indication of depression of the accelerator pedal, signaling a desire for increased vehicle speed. Vehicle acceleration may be directly proportional to accelerator pedal position, for example, degree of depression. In response, the controller 156 may command operations, such as shifting gear modes of the transmission 108. Alternatively, the gear modes of the transmission 108 may be shifted manually, such as if the transmission 108 is a manual transmission.

In some embodiments, additionally or alternatively, the transmission 108 may be a first transmission, and the vehicle 100 may have a second transmission arranged on the second set of axle shafts, the third shaft 128a and fourth shaft 128b. The transmission 108 may be a gearbox. Alternatively, the transmission 108 may be an axle transmission or a trans axle transmission.

A set of reference axes 201 are provided for comparison between views shown in FIGS. 2-3. The reference axes 201 indicate a y-axis, an x-axis, and a z-axis. In one example, the z-axis may be parallel with a direction of gravity, and the x-y plane may be parallel with a horizontal plane that a joint assembly 202 of FIG. 2 may rest upon. A circle may represent an axis of the reference axes 201 that is normal to a view. A filled circle may represent an arrow and axis facing toward, or positive to, a view. An unfilled circle may represent an arrow and an axis facing away, or negative to, a view.

Turning to FIG. 2, a first view 200 of the joint assembly 202 is shown. The first view 200 may be a sectional view of the joint assembly 202, showing a cut of the joint assembly 202 taken on a sectional plane that includes an axis 210 and is parallel with a plane formed by the y axis and z axis. The axis 210 may be a central axis, where the joint assembly 202 may be centered on, such as positioned around, such as radially around, the axis 210. The joint assembly 202 may have a first side 204 and a second side 206, where the first side 204 is opposite the second side 206. The joint assembly 202 may have an exterior 208, where the exterior 208 is a volume, such as packing space, that surrounds the joint assembly 202. The joint assembly 202 may be an example of the first joint 136, the second joint 138, the third joint 146, and/or the fourth joint 148 of FIG. 1.

The joint assembly 202 includes a CVJ 214, a flange component 216, a conductive component (shown in FIG. 3), and a shaft component 212. The CVJ 214 may be configured as a TMMB joint, for example. The CVJ 214 includes an outer race 220 with a weld seat 244. The flange component 216 includes a weld seat projection 234 on a first side 204, where the weld seat projection 234 is configured to mate with the weld seat 244 of the outer race 220. The conductive component joins the outer race 220 and the flange component 216 at an interface 250 between a second side of the flange component 216, opposite the first side, and the outer race 220. The shaft component 212 is drivingly coupled to the CVJ 214 at the weld seat 244 of the outer race 220. The CVJ 214 further comprises an inner race 286 and a cage 282 located between the outer race 220 and the inner race 286. A plurality of bearings, such as ball bearings, are located in an outer race track 264 of the outer race 220 and an inner race track 284 of the inner race 286. A lubricant fills an interior void of a scaling system, such as a boot can 228 configured to retain the lubricant and prevent contaminants from entering the CVJ 214. The CVJ 214 is mounted on a driveshaft tube, for example, using magnetic arc and/or friction welding.

The shaft component 212 may be a rotational element via which torque may be transferred to or from the CVJ 214. The shaft component 212 may physically and rotationally couple to the CVJ 214. The shaft component 212 may drive and rotationally couple to an input or an output, such as the first driveshaft 113, the second driveshaft 123, the first output 132, the second output 142, the first input 134, or the second input 144 of the vehicle 100 of FIG. 1. Likewise, torque may be transferred to and from the joint assembly 202 via the flange component 216. The flange component 216 may couple to an input or an output, such as the first driveshaft 113, the second driveshaft 123, the first output 132, the second output 142, the first input 134, or the second input 144 of the vehicle 100 of FIG. 1. When physically coupled, the flange component 216 and the outer race 220 may form a head assembly. As a head assembly, the flange component 216 and the outer race 220 may physically couple and drivingly couple to a rotational element, such as an input or an output to the joint assembly 202.

The shaft component 212 may be centered on a centerline 218, such that the shaft component 212 may be radially about the centerline 218. The centerline 218 may align with the axis 210 such as to be coaxial with axis 210. However, the centerline 218 may move out of alignment with the centerline 218. The shaft component 212 may include or physically couple to a shaft weld seat 222. The shaft weld seat 222 may be arranged at the opposite side of the joint assembly 202 from the flange component 216. The shaft weld seat 222 may couple to an input or an output, such as the first driveshaft 113, the second driveshaft 123, the first output 132, the second output 142, the first input 134, or the second input 144 of the vehicle 100 of FIG. 1. When coupled to a component, the shaft weld seat 222 may be drivingly coupled, such as to be driven by or drive the coupled component. The shaft component 212 may include a boot seat 224, extending between the shaft weld seat 222 and a tube-shaft spline 230. The tube-shaft spline 230 may be fit to the CVJ 214 by means of a splined hole in the inner race 286. When received via the CVJ 214, the tube-shaft spline 230 may drivingly couple the CVJ 214, such that the CVJ 214 may be driven via the shaft component 212. The shaft component 212 and the CVJ 214 may be centered on the axis 210.

A cover component may be positioned around, cover portions of, have surface sharing contact with, form a fluid seal against, and couple the shaft component 212. More specifically the cover component may flexibly couple to the shaft component 212, such that the shaft component may be rotated and/or spun while the cover component remains stationary relative thererto. The cover component may be rigidly coupled to the outer race 220 via a fastening component, where the fastening component may be rigidly coupled to and create a fluid seal against the outer race 220. The fluid seals between the cover component and the shaft component 212, the cover component and the fastening component, and the fastening component and the outer race 220 may be at least liquid tight and more specifically water tight. Said in another way, the fluid seals between the cover component and the shaft component 212, the cover component and the fastening component, and the fastening component and the outer race 220 may block and reduce liquids and at least water and aqueous fluid from entering from the exterior 208 to or leaking out from volumes between: the shaft component and the cover component, the shaft component and the fastening component, the cover component and the fastening component, the cover component and the outer race, and the fastening component and the outer race.

For example, a first portion of the boot seat 224 may be covered via a boot 226, where the boot is the cover component. The boot 226 may have surface sharing contact with and physically couple a second portion of journal that is smaller than and included by the first portion of the boot seat 224. The boot 226 may physically couple to the boot can 228, where the boot can 228 is the fastening component for the cover component. The boot can 228 may physically couple to the outer race 220. More specifically, the boot can 228 may rigidly couple to the outer race 220. The boot can 228 may physically couple and rigidly couple to the outer race 220 via a snap fit. The boot can 228 may have an extension that may be positioned around, press against, and snap to an outer surface or a plurality of outer surfaces of the outer race 220, such as a first surface 242.

Further, when coupled, the boot may create a fluid seal that is at least fluid tight. Said in another way, the boot 226 and the boot can 228 may fluidly seal a first cavity 252 of the outer race 220 from the exterior 208. The boot 226 and the boot can 228 may prevent the intrusion of water and dust into the cavity and into contact with the CVJ 214. The boot 226 and the boot can 228 may therein prevent degradation to the CVJ 214 via contact with water and dust. The boot 226 and the boot can 228 may further prevent degradation to the first cavity 252 and portions of the boot seat 224 via contact with components, features, or surfaces in the exterior 208. The boot 226, the boot can 228, and the first cavity 252 may form a first chamber 246, such as when the boot 226 couples the boot can 228 and the gasket couples the outer race 220. The first chamber 246 may be fluid tight and at least water tight, such as where the boot 226 and boot can 228 or another cover component and fastening component create seals with the shaft component 212 and the outer race 220 therearound. The first chamber 246 may house a lubricant, such as grease, for the CVJ 214 and the bearings thereof.

It is to be appreciated that there may be other configurations of cover components besides a boot. For another example, the cover component may be a jacket.

In addition to the boot 226 or other covering component, a fluid seal may be formed between the boot can 228 and outer race 220 via a seal component 245. The seal component 245 may be ring shaped (e.g., a ring shaped seal) such as an O-ring. The seal component 245 may be arranged between, such as radially between, press against, and create a fluid tight seal between and against boot can 228 and the outer race 220. More specifically, the seal component 245 may be arranged within a groove 247 and press against a plurality of groove surfaces (e.g., surfaces around and defining the volumetric shape of the groove 247). When pressed via the boot can 228, and more specifically the extension of the boot can 228 therearound, the seal component 245 may create fluid tight and at least water tight seals against one or more of the groove surfaces of groove 247.

The outer race 220 may physically couple to the weld seat projection 234 of the flange component 216. The weld seat projection 234 may be connected to a flange component fastener interface surface 238. The flange component fastener interface surface 238 may be a part of a head for the flange component 216, such as if the flange component 216 and the outer race 220 are part of a head assembly. Torque may be transferred from the CVJ 214 to the outer race 220, and to and across the flange component 216 similar to the transfer of torque across a disk style configuration of a joint assembly.

The flange component weld seat may be a projection, referred to herein as a weld seat projection 234, extending from the flange component 216. The flange component 216 may also include a passage 236 and the flange component fastener interface surface 238. The passage 236 may be concentric to the weld seat projection 234 and the flange component fastener interface surface 238. The weld seat projection 234 may be connected to the flange component fastener interface surface 238. The flange component fastener interface surface 238 may extend outward from the weld seat projection 234 and the passage 236, where outward is with respect to and away from the axis 210. Said in another way, the flange component fastener interface surface 238 may extend radially above the weld seat projection 234 and the passage 236. The flange component fastener interface surface 238 may have a plurality of holes 240. The holes 240 may be through passages, such as through holes or be formed with a thread. For an example, a plurality fastener may be passed through and received by the holes 240 to fasten the flange component fastener interface surface 238 to a rotational element, such as an input or an output companion flange. For this or another example, a plurality of dowels may be passed through and received by the holes 240. The outer race 220 may physically couple to the flange component 216, where the outer race 220 may physically couple the weld seat projection 234. The outer race 220 and the flange component 216 may be centered on the axis 210. For example, the outer race 220 and the flange component 216 may be positioned radially around the axis 210. When shaft component 212 becomes unaligned with the axis 210, the outer race 220 and the flange component 216 may remain centered on the axis 210.

The outer race 220 may include a plurality of features creating the “cup” shape of the outer race including the surfaces 242, 266, 268, 270, the outer race weld seat 244, and the region of the outer race 220 containing the tracks 264. The inner portions of the outer race are bounded by surfaces 242, 266, 268, 270 and the track region may form the first cavity 252. The outer race weld seat 244 may physically couple and make surface sharing contact with the weld seat projection 234. The boot can 228 may physically couple the track region of the outer race 220 such as via crimping.

The outer race weld seat 244 and the weld seat projection 234 may be joined at an interface 250, such as via a weld. The interface 250 may be a conductive area (e.g., a thermally conductive area) between the outer race 220 and the weld seat projection 234, via which heat transfer may occur. The CVJ 214 may drivingly couple to the weld seat projection 234, such that a torque from the CVJ 214 may drive the weld seat projection 234 and vice versa.

The outer race 220 may have a second cavity 254 and the flange component 216 may have a third cavity 256. An inner surface of a second flange may form the second cavity 254. An inner surface of the flange component 216 may form the third cavity 256. The second cavity 254 and the third cavity 256 may form a second chamber 248, such as when the second flange joins the flange component 216. The first cavity 252 may have a vent opening 260. The vent opening 260 may connect to and fluidly couple the second cavity 254 and the second chamber 248 to the CVJ interior. The opening 260 may extend through the wall 262.

The first cavity 252 may include the outer race track 264, a bore surface 266, a third surface 268, and a fourth surface 270. The outer race track 264, the surface 266, the third surface 268, and the fourth surface 270 may be inner surfaces of the outer race 220 and be radial with respect to the axis 210. The outer race track 264 and the fourth surface 270 may be curved and concave in shape. The second surface 266 and the third surface 268 may be curved and cylindrical in shape. The fourth surface 270 may be connected to and contiguous with the opening 260.

The outer race weld seat 244 may include a fifth surface 272, where the fifth surface 272 may be an inner surface of the outer race weld seat 244. Likewise, the flange component 216 may have a sixth surface 274, where the sixth surface 274 may be an inner surface of the weld seat projection 234. The fifth surface 272 and the sixth surface 274 may curve around the axis 210, such as radially about the axis 210. The fifth surface 272 may curve in an inward direction with, respect to the axis 210, toward the wall 262. The fifth surface 272 may be connected to the wall 262 and be contiguous with surfaces of the wall 262 surrounded by the third cavity 256. Likewise, the sixth surface 274 may curve in an inward direction, with respect to the axis 210, toward the passage 236. The sixth surface 274 may be contiguous with a seventh surface 276 of the passage 236. The seventh surface 276 may curve radially around the axis 210. The passage 236 may also have a mounting pilot 278 that curves radially around the axis 210. A first section of the passage 236 that includes the seventh surface 276 may have a smaller diameter than a second section of the passage 236 that includes the mounting pilot 278.

The CVJ 214 may include a plurality of joint parts including cage 282, an outer race 220, and an inner race 286. The cage 282 may be a carrier for a plurality of bearings. The cage 282 may be physically surrounded by the outer race 220 and the inner race via the spherical bearing surfaces. The cage 282 may therein be pivoted relative to the outer race 220 and the flange component 216. The inner race 286 may physically couple to the shaft component 212, such as via the tube-shaft spline 230. The inner race 286 may therein be pivoted with shaft component 212. As the shaft component 212 and the inner race 286 may be pivoted such that the centerline 218 is non-coaxial with the axis 210. The bearings (not shown) are constrained by the inner race tracks 284, the outer race tracks 264, and the cage windows. The bearings of the CVJ may be ball bearings.

The inner race 286 and the shaft component 212 may be pivoted at an angle 292 from the axis 210. The angle 292 is an angle at which the centerline 218 may be offset from being coaxial with the axis 210. The angle of the cage and the ball bearings contained within moves at one half of the angle 292 since the current embodiment shown is for a Rzeppa style joint. The position of the ball bearings is controlled by the track geometry and the cage windows. The joint experiences decreasing efficiency and increasing losses as the angle goes up. As the angle increases, the importance of heat transfer from the joint goes up.

Turning to FIG. 3, the first view 200 of the joint assembly 202 is shown, where joint assembly 202 of FIG. 3 includes a plurality of thermal conductors, such as a conductive component 322 housed via the second chamber 248. The conductive component 322 may be a solid of revolution that is cylindrical in nature. The conductive component 322 may physically couple the second cavity 254 and the third cavity 256. The conductive component 322 may physically couple the fifth surface 272, the sixth surface 274, and the interface 250, such as via joining. The conductive component 322 may curve radially with the curvature of the fifth surface 272 and the sixth surface 274 about the axis 210. The conductive component 322 may have a first inner surface 342. The first inner surface 342 may be level with and curve with the radius of the seventh surface 276.

The conductive component 322 may increase the surface area for heat transfer via conduction to occur between the outer race 220 and the flange component 216 beyond the interface 250. The conductive component 322 may act as a heat sink and conductor, removing thermal energy via conduction from the outer race 220 and transferring thermal energy to the flange component 216. Thermal energy will then be transferred to the axle, high speed propeller shaft, transfer case, and/or transmission to be dissipated. Thermal energy absorbed via the component 322 may also be removed via fluid, such as air, coolant, and/or lubricant, housed by the second chamber 248 via convection.

For an example, the conductive component 322 may comprise resin of a thermo-conductive material (e.g., a thermally conductive resin). As a resin, the conductive component 322 may be coated and cured to the fifth surface 272, the sixth surface 274, and the interface 250. Alternatively, for another example, the conductive component 322 may comprise a low melting point metal. For an example, as low melting point metal, the conductive component 322 may be soldered to the fifth surface 272, the sixth surface 274, and the interface 250. For another example, as a low melting point metal, the conductive component 322 may be welded or brazed as inserts to the fifth surface 272, the sixth surface 274, and the interface 250. For another example, the component 322 may comprise a thermally conductive and inert material, such as graphite. As a thermally conductive and inert material, the conductive component 322 may be joined as inserts to the fifth surface 272, the sixth surface 274, and the interface 250.

The disclosure also provides support for a joint assembly, comprising: a constant velocity joint having an outer race with a weld seat, a flange component with a weld seat projection on a first side, where the weld seat projection is configured to mate with the weld seat of the outer race, a conductive component that joins the outer race and the flange component at an interface between the outer race and a second side of the flange component, opposite the first side, and a shaft component drivingly coupled to the constant velocity joint, where the constant velocity joint is received by and drivingly coupled to the shaft component at the weld seat of the outer race. In a first example of the system, a chamber is formed between the outer race and the flange component, and the conductive component is removably positioned in the chamber. In a second example of the system, optionally including the first example, the system further comprises: a second conductive component positioned in the chamber. In a third example of the system, optionally including one or both of the first and second examples, the flange component comprises a passage fluidly coupled to the chamber, and wherein the passage is coaxial with a central axis of the outer race and the flange component. In a fourth example of the system, optionally including one or more or each of the first through third examples, the conductive component has a third surface, and the third surface is level with and curves with a fourth surface of the passage. In a fifth example of the system, optionally including one or more or each of the first through fourth examples, the conductive component comprises a thermally conductive resin. In a sixth example of the system, optionally including one or more or each of the first through fifth examples, the conductive component comprises a low melting point metal. In a seventh example of the system, optionally including one or more or each of the first through sixth examples, the conductive component is comprised of a conductive inert material. In an eighth example of the system, optionally including one or more or each of the first through seventh examples, the shaft component is coupled to the constant velocity joint via a boot can coupled to the outer race on a side of the outer race opposite the flange component, and where coupling of the boot can and the outer race creates a fluidly sealed cavity therebetween. In a ninth example of the system, optionally including one or more or each of the first through eighth examples, the constant velocity joint is configured as a tube mount mono-block (TMMB) joint including the outer race with the weld seat. In a tenth example of the system, optionally including one or more or each of the first through ninth examples, the shaft component is rotationally coupled to a rotational input and/or output. In an eleventh example of the system, optionally including one or more or each of the first through tenth examples, the flange component is rotationally coupled to a rotational input and/or output.

The disclosure also provides support for a constant velocity joint, comprising: a tube mount mono-block joint having a weld seat on a back face, a flange component with a weld seat projection on a front face, the weld seat projection configured to mate with the weld seat, and a conductive component positioned at an interface between the weld seat projection and the weld seat. In a first example of the system, the tube mount mono-block joint has an outer race, an inner race, and a cage positioned between the outer race and the inner race. In a second example of the system, optionally including the first example, the system further comprises: a plurality of balls located in an inner race track of the inner race and an outer race track of the outer race. In a third example of the system, optionally including one or both of the first and second examples, the outer race is coupled to the weld seat projection of the flange component at the weld seat of the tube mount mono-block joint. In a fourth example of the system, optionally including one or more or each of the first through third examples, the system further comprises: a scaling system. In a fifth example of the system, optionally including one or more or each of the first through fourth examples, the tube mount mono-block joint couples the constant velocity joint to a driveshaft tube.

Turning to FIG. 4, it shows a first example of a first method 400 for constructing and assembling a constant velocity joint assembly of the present disclosure, such as a constant velocity joint assembly 202.

The method 400 starts at 402 by assembling an outer race, a cage, bearings, and an inner race, forming a CVJ. For example, the outer race 220, the cage 282, the ball bearings, and the inner race 286 are assembled via 402 of method 400 to form the CVJ 214. 402 includes installing bearings in a holding feature of the outer race, such as the outer race track 264. 402 includes inserting the cage with the bearings into a volume of the outer race, while positioning the outer race around the cage and the bearings between the holding features of the outer race and the cage. Further construction of the CVJ includes inserting other bearings into other holding feature of the inner race, such as the inner race track 284. Further, the method 400 includes inserting the inner race with the bearings into a space surrounded by the cage, with the other bearings being positioned between the cage and the inner race.

Method 400 continues to 404, wherein the outer race and a flange section are secured to reduce undesired movement thereof.

Method 400 continues to 406, aligning the outer race and the flange section. Aligning includes arranging an outer projection of the outer race to face a flange of the flange component. Further, aligning includes overlapping a first area of the outer projection with a second area of a flange. The first area and second area overlap within a threshold of area. The outer projection may be a weld face.

Method 400 continues to 408, and includes applying joining material to one or more surfaces of the outer race and/or the flange section. For an example, joining material may be applied via welding. More specifically, joining material may be applied via soldering. For an example, the thermally conductive joining material may be a resin (e.g., a thermally conductive resin), and 408 includes transforming the resin into fluid state or plastic state and applying the resin to one or more surfaces of the outer race and/or flange section, such as via melting and soldering, respectively. For another example, the joining material may be a low melting point metal, metalloid, or alloy, and 408 includes transforming the low melting point metal, metalloid, or alloy into a fluid state and applying the low melting point metal to one or more surfaces of the outer race and/or flange section, such as via melting and soldering, respectively.

408 includes a plurality of sub-steps, including 412 and 414. At 412, first method 400 includes applying joining material to at least the first area of the outer projection. At 414, method 400 includes applying joining material to at least the second area of the flange. Either 412 or 414 may be completed as a part of applying joining material at 408. Said in another way, if 412 completed as part of 408, 414 may be optional and vice versa. It is to be appreciated, 408 may include both 412 and 414.

Method 400 continues 422, and includes joining the outer race and the flange section, and more specifically, joining the outer projection and the flange via the conductive joining material. Joining includes, joining the outer race and the flange section into a unitary structure. Joining outer projection and the flange includes forming a cavity via the outer race and the flange, where the outer race and the flange component are positioned around the cavity and the cavity is arranged between the outer race and the flange component. The outer race and the flange component may enclose the cavity.

Method 400 continues to 424 and includes inserting a conductive component within the cavity formed between and within the surfaces of the outer race and the flange component. Further 424 may include forming the conductive component into a desired shape during the insertion and application of material of the conductive component in the cavity. The conductive component comprises a thermally conductive material and may be the conductive component 322 of FIG. 3. Inserting and forming the conductive component to the cavity may include arranging the conductive component into a solid of revolution that is cylindrical in nature within the cavity. The conductive component is insertable to the cavity and appliable to the surfaces around the cavity via a passage of the flange component open to an exterior and volumetrically connected to the cavity. For example, the conductive component may be inserted into the cavity, and applied and joined to the surfaces around the cavity via the passage 236 of FIGS. 2-3.

For an example, the conductive component comprises thermally conductive resin. For another example, the conductive component comprises a low melting point metal, metalloid, or alloy. For these examples, the conductive component as conductive resin, low melting point metal, low melting point metalloid, and/or the low melting point alloy may be applied in contact with the inner surfaces around the cavity as a liquid, plastic, or another fluid state. It is to be appreciated, that the thermally conductive material of the conductive component may be the same material as the joining material. Said in another way, the thermally conductive material and the joining material may be a common material, sharing approximately the same chemical composition.

During insertion to the cavity and application to the outer race and the flange component, 424 may include depositing and solidifying the conductive material of the conductive component while spinning the outer race and flange component around an axis. The spinning, depositing, and cooling of the conductive material includes forming conductive material into a shape, such as a solid of revolution that is cylindrical in nature. Further the spinning, depositing, and cooling conductive material includes forming the conductive component via an additive manufacturing process. The spinning and deposition may continue until the conductive material of the conductive component is a desired thickness equal to or greater than a threshold of thickness. For an example of these examples, the depositing and additively forming the conductive material into the conductive component may done be via welding and/or soldering the conductive material.

Method 400 continues to 426 and includes joining the conductive component to the outer race, the flange, and the conductive joining material. The conductive joining material may be joined to the outer race, the flange component, and the conductive joining material via welding.

Method 400 continues to 428 and includes rigidly coupling a shaft component to the inner race. The shaft component may be the shaft component 212 of FIGS. 2-3. For an example, method 400 may include inserting and rigidly coupling shaft component to the inner race via a hole such thereof, where the hole may be a socket. The shaft component may include at least a first fastening feature and the inner race may include at least a second fastening feature, where the second fastening feature is positioned around the hole and mateable with the first fastening feature. At 428 the method 400 may therefore include mating the first fastening feature with the second fastening feature via inserting the shaft component into the hole. For example, the hole may be a splined hole with one or more splines or grooves for splines therearound, and a spline(s) of the shaft component, such as the tube-shaft spline(s) 230, may be fit to the one or more splines or the one or more grooves of the inner race around the splined hole.

Method 400 continues to 430 and includes attaching and rigidly coupling a fastening component to the outer race, where the fastening component is for coupling a covering to the CVJ. 430 includes creating a fluid seal that liquid tight and, more specifically, at least water tight between the fastening component and one or more outer surfaces of the outer race. For example, coupling the fastening component may include snap fitting the fastening component to the outer race. The fastening component may be for a boot, such as a boot can, such as the boot can 228.

Method 400 continues to 432 and includes covering a cover component (e.g., a covering) around a shaft component. Further, 432 includes coupling the cover component to the shaft component and the fastening component rigidly coupled to the outer race. At 432, method 400 includes flexibly coupling the cover component to the shaft, such that the shaft is rotatable separately from the cover component. 432 includes creating a fluid seal that is liquid tight and, more specifically, at least a water tight seal between the boot and one or more outer surfaces of the shaft component. Likewise, method 400 at 432 includes rigidly coupling the cover component to the fastening component. For an example, the covering is a boot, such as boot 226. Method 400 at 432 includes rigidly coupling the boot to the boot can and therein rigidly coupling the boot to the outer race.

After 432, method 400 ends.

It is to be appreciated that 432 and 430 may be reversed for another example, with 432 occurring before 432. For this example, after 430, method 400 ends.

Likewise, it is to be appreciated for another example, that 430 and/or 432 may occur before rigidly coupling the shaft component to the inner race at 428. For this example, after 428, method 400 ends.

Turning to FIG. 5, it shows a first example of a second method 500 for constructing and assembling a constant velocity joint assembly of the present disclosure, such as a constant velocity joint assembly 202. Method 500 includes many of the steps of method 400 of FIG. 4, and may not be repeated for brevity.

Method 500 diverges from method 400 after 406. After 406, method 500 proceeds to 512, joining a conductive component and a first housing component via a thermally conductive joining material. The first housing component may be the either the outer race or the flange component described method 400. The joining material may be the same joining material of method 400 and/or used to join the outer race and flange at 408. The conductive component is joined to the outer race or the flange section via the joining material. The joining material may be turned to a fluid or a malleable plastic, such as via melting, and the joining material may be joined to the surface of the first housing component via welding and soldering.

The conductive component of method 500 is thermally conductive insert or plurality of inserts comprised of a material of a solid phase state or a plastic phase state. The conductive component of method 500 may be the conductive component 322 of FIGS. 2-3. For an example, the conductive component of method 500 comprises a resin (e.g., a thermally conductive resin), where the resin is in solid phase state or a plastic phase state. For another example, the conductive component comprises a low melting point metal, metalloid, or alloy in a solid phase state or a plastic phase state. For another example, the conductive component comprises another solid thermally conductive material, such as graphite. For these examples, the conductive component may include a plurality of smaller components positioned and/or coupled together to form the conductive component. For example, joining and rigidly coupling the sub components of the conductive component to the first housing arrange the sub components into a final shape for the conductive component, such as a solid of revolution that is cylindrical in nature.

After 512, method 500 continues to 408, applying the joining material to the joining surfaces of the outer race and the flange component.

After 408, method 500 diverges from method 400. After 408, method 500 continues to 524 and includes covering the conductive component with a second housing. For an example, if the first housing is the outer race, the second housing is the flange component. For another example if the first housing is the flange component, the second housing is the outer race.

After 524, method 500 continues to 422, joining the outer race and the flange into a unitary structure.

After 422, method 500 diverges from method 400. After 422, method 500 continues to 528 joining the thermally conductive component to the second housing and the joining material between the outer projection of the outer race and the flange of the flange section. Joining at 528 may include melting and applying additional joining material to one or more surfaces of the second housing and a joining section that joins outer race and the flange component. The joining section includes joining material applied at 408 and used to join the flange and outer race into a unitary component at 422. Once applied, 528 includes placing the additional joining material into surface sharing contact with the thermal conducting component, and cooling the additional joining material into a solid. The additional joining material may be applied and joined via welding. More specifically, the joining material may be applied and joined via soldering. The additional joining material is also a thermally conductive joining material. Further, the additional joining material and the joining material of the joining section may be the same material. Said in another way, the additional joining material and the joining material may be a common material. For an example, the thermally conductive joining material is a resin (e.g., a thermally conductive resin), and 528 includes transforming the resin into fluid state or plastic state and applying the resin to one or more surfaces of the outer race and/or flange section, such as via melting and soldering, respectively. For another example, the additional joining material may be a low melting point metal, metalloid, or alloy, and 528 includes transforming the low melting point metal, metalloid, or alloy into a fluid state and applying the low melting point metal to one or more surfaces of the outer race and/or flange section, such as via melting and soldering, respectively.

After 528, method 500 continues to 428, rigidly coupling a fastener for a cover to the outer race.

As with method 400, after 432, method 500 ends.

Likewise, for method 500, it is to be appreciated that 432 and 430 may be reversed for another example, with 430 occurring before 432. For this example, after 430, method 500 ends.

Likewise, it is to be appreciated it is to be appreciated for another example, that 430 and/or 432 may occur before rigidly coupling the shaft component to the inner race at 428. For this other example, after 428, method 500 ends.

The methods 400 and 500 of FIGS. 4-5 of the disclosure also provides support for a method of manufacturing a constant velocity joint assembly, including: arranging an outer projection of an outer race to face a flange of a larger flange component, overlapping a first area of the outer projection with a second area of the flange, joining the outer projection of the outer race to the flange via a conductive joining material, forming a cavity via the outer race and the flange component, applying a conductive component to a plurality of surfaces of the outer race and the flange component around the cavity, and joining the conductive component to the conductive joining material. In a first example of the method including applying and joining the conductive joining material to the outer race, the flange component, and the conductive joining material via welding, and where the outer projection is a weld face. In a second example of the method, optionally including the first example including having the conductive joining material and the conductive component comprise a common material. In a third example of the method, optionally including one or both of the first and second examples included arranging the conductive component into a solid of revolution that is cylindrical in nature within the cavity.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible.

For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A joint assembly, comprising:
a constant velocity joint having an outer race with a weld seat;
a flange component with a weld seat projection on a first side, where the weld seat projection is configured to mate with the weld seat of the outer race;
a conductive component that joins the outer race and the flange component at an interface between the outer race and a second side of the flange component, opposite the first side; and
a shaft component drivingly coupled to the constant velocity joint, where the constant velocity joint is received by and drivingly coupled to the shaft component at the weld seat of the outer race.

2. The joint assembly of claim 1, wherein a chamber is formed between the outer race and the flange component, and the conductive component is removably positioned in the chamber.

3. The joint assembly of claim 2, further comprising a second conductive component positioned in the chamber.

4. The joint assembly of claim 2, wherein the flange component comprises a passage fluidly coupled to the chamber, and wherein the passage is coaxial with a central axis of the outer race and the flange component.

5. The joint assembly of claim 4, where the conductive component has a third surface, and the third surface is level with and curves with a fourth surface of the passage.

6. The joint assembly of claim 1, where the conductive component comprises a thermally conductive resin.

7. The joint assembly of claim 1, where the conductive component comprises a low melting point metal.

8. The joint assembly of claim 1, where the conductive component is comprised of a conductive inert material.

9. The joint assembly of claim 1, wherein the shaft component is coupled to the constant velocity joint via a boot can coupled to the outer race on a side of the outer race opposite the flange component, and where coupling of the boot can and the outer race creates a fluidly sealed cavity therebetween.

10. The joint assembly of claim 1, wherein the constant velocity joint is configured as a tube mount mono-block (TMMB) joint including the outer race with the weld seat.

11. The joint assembly of claim 1, wherein the shaft component is configured to be rotationally coupled to a rotational input and/or output.

12. The joint assembly of claim 1, wherein the flange component is configured to be rotationally coupled to a rotational input and/or output.

13. A constant velocity joint, comprising:
a tube mount mono-block joint having a weld seat on a back face;
a flange component with a weld seat projection on a front face, the weld seat projection configured to mate with the weld seat; and
a conductive component positioned at an interface between the weld seat projection and the weld seat.

14. The constant velocity joint of claim 13, wherein the tube mount mono-block joint has an outer race, an inner race, and a cage positioned between the outer race and the inner race.

15. The constant velocity joint of claim 14, further comprising a plurality of balls located in an inner race track of the inner race and an outer race track of the outer race.

16. The constant velocity joint of claim 14, wherein the outer race is coupled to the weld seat projection of the flange component at the weld seat of the tube mount mono-block joint.

17. The constant velocity joint of claim 13, further comprising a sealing system.

18. The constant velocity joint of claim 13, wherein the tube mount mono-block joint is configured to couple the constant velocity joint to a driveshaft tube.

19. A method of manufacturing a constant velocity joint assembly, including:
arranging an outer projection of an outer race to face a flange of a larger flange component;
overlapping a first area of the outer projection with a second area of the flange;
joining the outer projection of the outer race to the flange via a conductive joining material;
forming a cavity via the outer race and the flange component;
applying a conductive component to a plurality of surfaces of the outer race and the flange component around the cavity; and
joining the conductive component to the conductive joining material.

20. The method of manufacturing of claim 19, including applying and joining the conductive joining material to the outer race, the flange component, and the conductive joining material via welding, and where the outer projection is a weld face.
